(19) United States
(12) Patent Application Publication
(10) Pub. No.: US 2018/0187082 A1
(43) Pub. Date: Jul. 5, 2018

(54) METHOD FOR MANUFACTURING A FIRE-RESISTANT MATERIAL BASED ON HOMOGENEOUS FOAM PRODUCTS

(71) Applicant: Imerys Metalcasting Germany GmbH, Oberhausen (DE)

(72) Inventor: Sebastian PETERS, Telgte (DE)

(21) Appl. No.: 15/558,802

(22) PCT Filed: Mar. 16, 2016
(86) PCT No.: PCT/EP2016/055714

§ 371 Date: Feb. 2, 2018

(30) Foreign Application Priority Data
Mar. 16, 2015 (DE) 10 2015 103 831.5

(51) Int. Cl. C09K 21/02; C03C 3/108; C03C 17/30; C08K 7/28; C08L 101/12; C09K 3/10; H01B 3/18

(52) U.S. Cl. CPC C09K 21/02; C03C 3/108; C03C 17/30; C08K 7/28; C08L 101/12; C09K 3/10; C09K 2003/1078; C03C 2203/20; C03C 2203/50; C03C 2217/76; C03C 2218/31; C09K 2003/1053; H01B 3/18

(57) ABSTRACT

The object of the present invention is a method for producing a fire retardant on the basis of homogeneous foam products. In such a method, a glass is first reacted with an aqueous alkali metal hydroxide solution at temperatures above 50° C. The reaction product is extracted as a viscous mass, granulated, and cooled until a solid granulated product is obtained. According to the invention, the granules are furnished with a hydrophobic coating having a layer thickness of about. 20 μm to 500 μm and are particularly 50 μm to 200 μm and preferably 50 μm to 100 μm and are incorporated in a construction material as a fire retardant additive.

The invention relates to a method for producing a fire retardant on the basis of homogeneous foam products, according to which a glass is reacted with an aqueous alkali metal hydroxide solution at temperatures above 50° C. and the reaction product is extracted as a viscous mass, granulated, and cooled until a solid granulated product is obtained.

Homogeneous foam products made of glass and the preparation thereof are described in the species-defining EP 1 183 215 B1. According to this document, it is already known to react glasses with an alkali metal hydroxide solution at elevated temperatures above 50° C. The reaction product is a homogeneous, viscous mass which can be extracted in the plastic state. As soon as this mass cools down, dry, hard granulate particles form—that is to say the desired solid granules. In general, this approach has proven effective. The homogeneous foam products or granules produced in this way may be used for a variety of purposes, including as insulating material or also as sound absorbers, and are notable for their low specific weight as well as their fire retardant effect.

The fire retardant behaviour of such foam products is also described in U.S. Pat. No. 4,521,333, which is also species-defining (see the notes in the “Technical Field” section). To this extent, foam products and/or corresponding granules have proven effective in this context. However the problem of the long-term stability of the granules in the face of water penetration still represents an area requiring improvement. Moreover, the processing of the granules when they are used as a fire retardant additive for construction material is not ideal. The invention is intended to provide improvement in this area.

The technical problem the invention is intended to address is that of refining such a method for producing a fire retardant on the basis of homogeneous foam products in such a way that processing as a fire retardant additive in conjunction with a construction material is made easier, and the long-term stability of the granules is improved with respect to the prior art.

In order to solve this set of technical problems, a species-related method for producing a fire retardant on the basis of homogeneous foam products within the scope of the invention is characterized in that the granules are furnished with a hydrophobic coating having a layer thickness from about 20 μm to 500 μm, particularly 50 μm to 200 μm and preferably 50 μm to 100 μm and are incorporated in a construction material as a fire retardant additive.

The granules as such have a grain diameter typically in the range from 0.5 to 15 mm, particularly 1 mm to 10 mm and preferably 1 mm to 5 mm. As a rule, it is possible to achieve this by extracting the viscous mass, granulating and cooling it, and if necessary comminuting and filtering it.

The application of the hydrophobic coating to the solid granules based on homogeneous foam products taking into account the specified layer thickness firstly ensures that the long-term stability of the granules is increased significantly compared with the prior art.

Because the hydrophobic coating prevents any moisture from penetrating the granules, so that the specific weight of the granules remains substantially unchanged, as well as the fraction of water included in the interior thereof. Consequently, the fire retardant agent produced according to the invention still remains viable even after a long storage period and is advantageously suitable for use as a lightweight aggregate and/or fire retardant additive for incorporation in the desired construction material. The assured properties remain intact.

In fact, the bulk volume or bulk density of the solid granules produced according to the invention is between 0.01 and 0.05 g/cm³ and this bulk volume is retained even over long timescales of up to a year or even longer due to the hydrophobic coating with the indicated layer thickness.

In addition as a further aspect, according to which the hydrophobic coating created with the indicated layer thickness of about 20 μm to 500 μm makes it easier to incorporate the granules coated in this way in the construction material. In this respect, the invention proceeds from the finding that typically polymers and particularly plastics are used as construction material. Most particularly preferred for use as construction materials are elastomers, which are involved in making seals, electrical insulation materials, electrical cables, cable ducts etc. In this context, the hydrophobic coating with which the granules are furnished according to the invention then ensures that the granules can be readily worked into such elastomers. In this respect, the invention proceeds from the finding that, for example, the formation of agglomerates is favoured by the addition of wax to rubber particles. This means that rubber and wax are compatible with each other as a possible hydrophobic coating for the granules.

The hydrophobic coating for the granules is added in a total proportion of 0.5 wt % to 2 wt %, relative in each case to an initial weight of the foam product. The initial weight of the foam product is constituted of the basic components of the glass used, the alkali metal hydroxide and water as the solvent. The hydrophobic coating is then also added to this in the grammage indicated.

According to the invention, materials or substances recommended for use in the hydrophobic coating include not only wax, but generally also silicones, silicone oils, silanols etc., provided the hydrophobic and therewith the water-repellent character is preserved to prevent water from penetrating or being able to penetrate the individual granulates coated in this manner during storage.

The glasses that are used are advantageously a recycled glass, a synthetic glass, a mineral glass of natural origin or mixtures of said glasses. Recycled glass is characterized by a high content of borosilicate and is consequently referred to as recycled boron glass. In fact, the glasses used most often contain 60 to 85 wt % SiO₂, 4 to 27 wt % Na₂O, 0 to 5 wt % K₂O, 0 to 8 wt % CaO, 0 to 5 wt % Al₂O₃, 0 to 14 wt % B₂O₃, 0 to 20 wt % PbO, 0 to 5 wt % MgO and 0 to 8 wt % BaO. The glasses used are particularly preferably constituted from 65 to 80 wt % SiO₂, 4 to 14 wt % N₂O, 0 to 3 wt % K₂O, 0 to 3 wt % CaO, 1 to 3 wt % Al₂O₃, 5 to 13 wt % Pb₂O₃, 0 to 5 wt % PbO, 0 to 3 wt % MgO and 0 to 3 wt % BaO.

According to the invention, the mixture of the glass and the aqueous alkali metal hydroxide solution is reacted at temperatures above 50° C. As a rule, the mixture in question is heated to temperatures in the range between about 120° C. and 250° C. This may be carried out under normal pressure. Alternatively, however, it is also possible to carry out the described reaction in an autoclave at the specified temperatures from 120° C. to 250° C. and under pressure of 2 to 15 bar.

As explained above, a large number of hydrophobic materials may be used to create the hydrophobic coating for the granules produced including, for example, silicones. This means that the hydrophobic coating advantageously consists of silicones, which are not dilutable in water. In this context, the silicones in question, which are not dilutable in water lend themselves not only to use as the coating but may also be introduced into the interior of the granules. As a rule, the hydrophobic coating is mixed with the starting materials at the beginning of production. For example, the material concerned may be added to the water. This is successful even though the hydrophobic coating and the materials used at this point are practically insoluble in water. Nevertheless, and surprisingly, it is possible in this way for the emulsion of water and hydrophobic constituent not to separate but to precipitate on the individual granules produced as a hydrophobic coating, and under certain circumstances to penetrate the granules. In general, however, it is also possible to apply the hydrophobic coating only to the granules after they have been produced, for example, by spraying.

Fillers and/or reinforcing agents may also be added to the mixture of the glass and the alkali metal hydroxide solution. Such fillers and reinforcing agents are advantageously wollastonite, mica, glass fibres, quartz, talcum, zinc oxide, titanium oxide and the like. These fillers and reinforcing agents serve to improve the overall compression strength of the granules produced. Moreover it is possible to lend the granules a white colour, for example, to facilitate the subsequent incorporation in the construction material and to make it transparent and visible.

In general, water-dilutable additives such as glycerin and/or ethylene glycol may also be added. It may also be advisable to add generally OH-functional water-dilutable additives such as the glycerin and/or ethylene glycol referred to lower the bulk density. This is usually done with a proportion by weight of 0.5 to 2.5 wt %, relative to the initial mixture of the foam products. In principle, it is also possible to additionally add an aqueous alkali metal silicate solution to the aqueous suspension of the glass and alkali metal hydroxide solution—The residual water content of granules produced in this way is typically in the range of 20 to 35 wt %. In such a case, both the said residual water content and the ability of the granules produced from the homogeneous foam products to swell up ensure that the desired fire retardant behaviour is preserved.

In fact, the outbreak of a fire and the elevated temperatures that accompany such an occurrence cause the fire retardant additive in the construction material concerned to release the water included inside it in the first step. This usually takes place in a temperature range up to about 300° C. In this context, the water content of 20 to 35 wt % present inside the granules primarily serves to cool the construction material due to the steam which is generated, so that desired fire retardant effect is realised.

Above 300° C. or after the water included in the granules has evaporated, said granules then swell up as they have been produced from the foam products. This swelling or foaming is called thermal inflation which corresponds to an endothermic process. This means that the swelling process which typically begins above 300° C. also contributes, due to its endothermic heat-consuming character, to the cooling effect on the construction material and therewith also the desired fire retardant effect.

The following overall starting mixture serves as the basis for production of the foam product:
about 50 to 60 wt % glass;
about 15 to 20 wt % alkali metal hydroxide, dry,
about 20 to 35 wt % water, and
about 0.5 to 2 wt % of the hydrophobic coating.

Optionally, about 5 to 10 wt % of filler and/or reinforcement agents may also be added, as was described in detail previously. The fire retardant is typically produced in such manner that the specified grammage of glass, for example 50 to 60 wt % recycled boron glass is mixed dry with 18 wt % NaOH as the alkali metal hydroxide. Then about 30 wt % water is added, and this is followed by the further mixing and reaction at temperatures in the range from 10° C. to 120 ° C. under normal pressure. The reaction is carried out for a total of several minutes, for example, 20 minutes. The result is a homogeneous viscous mass which is extracted in the plastic state and for example pressed through a perforated disc.

The mass may be cut up with the aid of a cutting device located on the outer side of the perforated disc, and powdered with quartz flour powder, for example, to prevent possible agglomerations or caking. After cooling to room temperature, hard, dry granulate particles or granules having the specified grain size between 0.5 mm and 15 mm in an embodiment in the range from about 1 mm to 5 mm are observed. At the same time, the grains are furnished with the hydrophobic coating having a layer thickness of 50 μm to 100 μm. As the hydrophobic coating was added to the water in the form of silicone oil an outer layer on the granules was formed or was deposited during the reaction and while the granules were curing.

Of course, it is also generally possible to furnish the granules with the hydrophobic coating as necessary by spraying. The fire retardant agent produced in this way is then worked into the desired construction material.

This may be carried out for example in such manner that an elastomer is used as the construction material, and the granules are poured into an extruder as an additive, together with the granulate of the construction material. In this way, the granules or fire retardant substance are distributed homogeneously within the construction material when it emerges in the desired form at the extruder outlet. Such forms may be seals, insulation materials for cables, cable ducts, etc., as was described in the introduction.

1. A method comprising:
reacting a glass with an aqueous alkali metal hydroxide solution at a temperature above 50° C.,
extracting a reaction product a viscous mass, granulating and cooling the reaction product to form solid granules, and
furnishing the granules with a hydrophobic coating having a layer thickness of about 20 μm to 500 μm.

2. A method according to claim 1, further comprising
incorporating the granules into a foam product,
wherein the hydrophobic coating is added in a proportion of 0.5 wt % to 2 wt %, relative to the starting weight of the foam product.

3. A method according to claim 1, wherein the mixture of the glass and the aqueous alkali metal hydroxide solution is heated to temperatures of 120° C. to 250° C.

4. A method according to claim 1 wherein the glass is a recycled glass, a synthetic glass, a mineral glass of natural origin, or a mixture thereof.

5. A method according to claim 1, wherein the glass comprises:
60 to 85 wt % SiO2,
4 to 27 wt % Na2O,
0 to 5 wt % K2O,
0 to 8 wt % CaO,
0 to 5 wt % Al2O3,
0 to 14 wt % B2O3,
0 to 20 wt % PbO,
0 to 5 wt % MgO, and
0 to 8 wt % BaO.

6. A method according to claim 1, wherein the hydrophobic coating comprises a non-water-dilutable silicone.

7. A method according to claim 6, wherein the non-water-dilutable silicone is applied as a coating and is introduced into the interior of the granules.

8. A method according to claim 1, wherein wollastonite, mica, or another filler or reinforcement agent is added to the mixture of the glass and the alkali metal hydroxide solution.

9. A method according to claim 1, further comprising:
incorporating the granules into a foam product,
wherein a starting mixture for the foam product comprises:
about 50 to 60 wt % glass;
about 15 to 20 wt % alkali metal hydroxide, dry,
about 20 to 35 wt % water, and
about 0.5 to 2 wt % of the hydrophobic coating.

10. A method according to claim 1, further comprising adding the granules to a polymer used as a construction material.

11. A method according to claim 1, further comprising incorporating the granules into a homogenous fire retardant foam product.

12. A method according to claim 11, further comprising incorporating the foam product into a construction product.

13. A method according to claim 12, wherein the construction product is a seal or a cable insulation material.

14. A method according to claim 3, wherein the mixture of the glass and the aqueous alkali metal hydroxide solution is heated in an autoclave under pressure of 2 to 15 bar.

15. A method according to claim 9, wherein the starting mixture further comprises about 5 to 10 wt % of filler and reinforcement agents.

16. A method according to claim 10, wherein the polymer is an elastomer.

17. A method according to claim 10, wherein the construction material is used to produce a seals or a cable insulation material.
